(19) United States
(12) Patent Application Publication
(10) Pub. No.: US 2013/0098872 A1
(43) Pub. Date: Apr. 25, 2013

(54) SWITCHED ELECTRON BEAM PLASMA SOURCE ARRAY FOR UNIFORM PLASMA PRODUCTION

(71) Applicants: Leonid Dorf, San Jose, CA (US); Shahid Rauf, Pleasanton, CA (US); Kenneth S. Collins, San Jose, CA (US); Nipun Misra, San Jose, CA (US); James D. Carducci, Sunnyvale, CA (US); Gary Leray, Mountain View, CA (US); Kartik Ramaswamy, San Jose, CA (US)

(72) Inventors: Leonid Dorf, San Jose, CA (US); Shahid Rauf, Pleasanton, CA (US); Kenneth S. Collins, San Jose, CA (US); Nipun Misra, San Jose, CA (US); James D. Carducci, Sunnyvale, CA (US); Gary Leray, Mountain View, CA (US); Kartik Ramaswamy, San Jose, CA (US)

(73) Assignee: Applied Materials, Inc., Santa Clara, CA (US)

(21) Appl. No.: 13/595,134

(22) Filed: Aug. 27, 2012

Related U.S. Application Data
(60) Provisional application No. 61/549,336, filed on Oct. 20, 2011.

(51) Int. Cl. H05H 1/24; B44C 1/22

(52) U.S. Cl. 216/67; 156/345.4; 156/345.24; 156/345.33

(57) ABSTRACT

An array of electron beam sources surrounding a processing region of a plasma reactor is periodically switched to change electron beam propagation direction and remove or reduce non-uniformities.

### CROSS-REFERENCE TO RELATED APPLICATIONS

This application claims the benefit of U.S. Provisional Application Ser. No. 61/549,336, filed Oct. 20, 2011 entitled SWITCHED ELECTRON BEAM PLASMA SOURCE ARRAY FOR UNIFORM PLASMA PRODUCTION, by Leonid Dorf, et al.

### BACKGROUND

A plasma reactor for processing a workplace can employ an electron beam as a plasma source. Such a plasma reactor can exhibit non-uniform distribution of processing results (e.g., distribution of etch rate across the surface of a workplace) due to non-uniform distribution of electron density and/or kinetic energy within the electron beam. Such non-uniformities can be distributed along the direction of beam propagation and can also be distributed in a direction transverse to the beam propagation direction.

### SUMMARY

A plasma reactor comprises a processing chamber comprising a side wall, a floor and a ceiling, and a workpiece support pedestal within said chamber having a workpiece support plane and defining a processing region between said workpiece support plane and said ceiling. There is provided an array of electron beam sources having respective beam emission axes facing said processing region, said array of electron beam sources being outside of said chamber, said side wall comprising respective apertures in registration with respective ones of said beam emission axes. There is further provided an array of beam dumps (electron current collectors) aligned with said array of electron beam source and respective servos coupled to respective ones of said beam dumps, each of said beam dumps being separately movable between a beam-blocking position and an unblocking position. A controller is coupled to said respective servos.

In a further aspect, there is provided an array of beam-confining magnetic field sources aligned with respective ones of said beam emission axes and respective current sources coupled to respective ones of said beam-confining magnetic field sources and having reversible current polarities. The controller is further coupled to said respective current sources. In one embodiment, opposing pairs of said electron beam sources share respective ones of said beam emission axes, and the controller is programmed to periodically cause a reversal of electron beam propagation direction along respective ones of said beam emission axes.

### BRIEF DESCRIPTION OF THE DRAWINGS

So that the manner in which the exemplary embodiments of the present invention are attained and can be understood in detail, a more particular description of the invention, briefly summarised above, may be had by reference to the embodiments thereof which are illustrated in the appended drawings. It is to be appreciated that certain well known processes are not discussed herein in order to not obscure the invention.

FIGS. 1A, 1B and 1C are elevational views of a plasma reactor having a pair of opposing beam sources, in which beam propagation direction along the beam emission axis is reversible at desired rate. The beam sources employ D.C discharges as plasma sources in a first embodiment.

FIGS. 2 and 3 are plan views of a plasma reactor having an array of electron beam sources around the outside of the plasma reactor chamber, in which beam propagation direction is changeable in two dimensions.

FIGS. 4A through 4E are contemporaneous timing diagrams depicting an example of a mode for operating the plasma reactor of FIGS. 2 and 3.

FIGS. 5A and 5B depict an electron beam source for the plasma reactor of FIG. 1A or 2, employing a toroidal plasma source.

FIG. 6 depicts an electron beam source for the plasma reactor of FIG. 1A or 2, employing a capacitively coupled plasma source.

FIGS. 7A and 7B are side and end views, respectively, of an electron beam source for the plasma reactor of FIG. 1A or 2, employing an inductively coupled plasma source.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

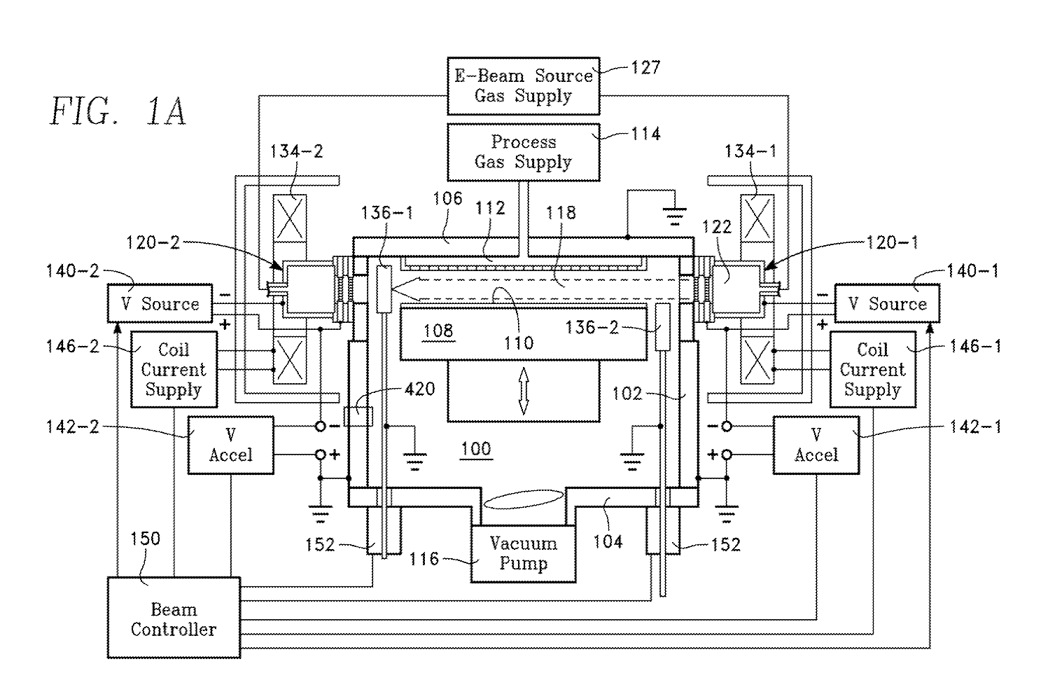

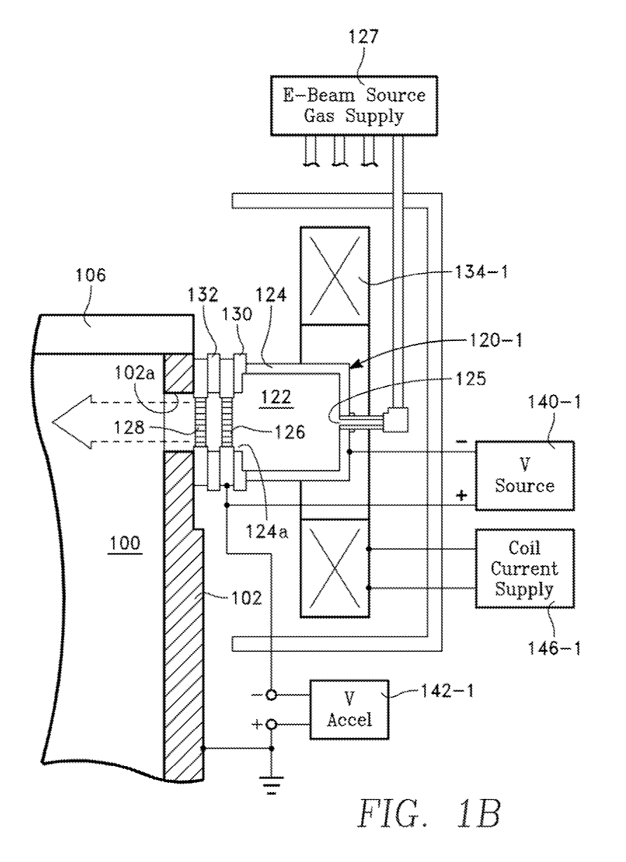

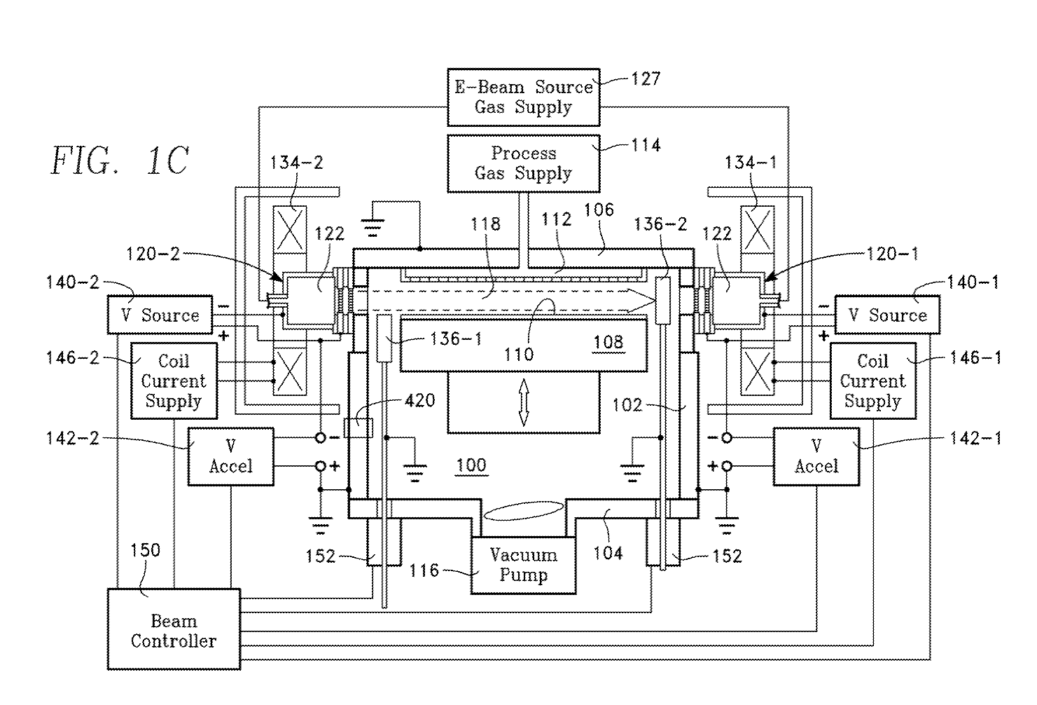

FIG. 1A depicts a plasma reactor having an electron beam plasma source. The reactor includes a process chamber 100 enclosed by a cylindrical side wall 102, a floor 104 and a ceiling 106. A workpiece support pedestal 108 supports a workpiece 110, such as a semiconductor wafer, the pedestal 108 being movable in the axial (e.g., vertical) direction. A gas distribution plate 112 is integrated with or mounted on the ceiling 106, and receives process gas from a process gas supply 114. A vacuum pump 116 evacuates the chamber through the floor 104. A process region 118 is defined between the workpiece 110 and the gas distribution plate 112. Within the process region 118, the process gas is ionized to produce a plasma for processing of the workpiece 110.

The plasma is generated in process region 118 by an electron beam. In FIG. 1A, a first electron beam source 120-1 includes a plasma generation chamber 122 outside of the process chamber 100 and having a conductive enclosure 124. The electron beam source 120-1 is best seen in the enlarged view of FIG. 1B. The conductive enclosure 124 has a gas inlet or neck 125. An electron beam source gas supply 127 is coupled to the gas inlet 125. The conductive enclosure 124 has an opening 124a facing the process region 118 through an opening 102a in the sidewall 102 of the process chamber 100.

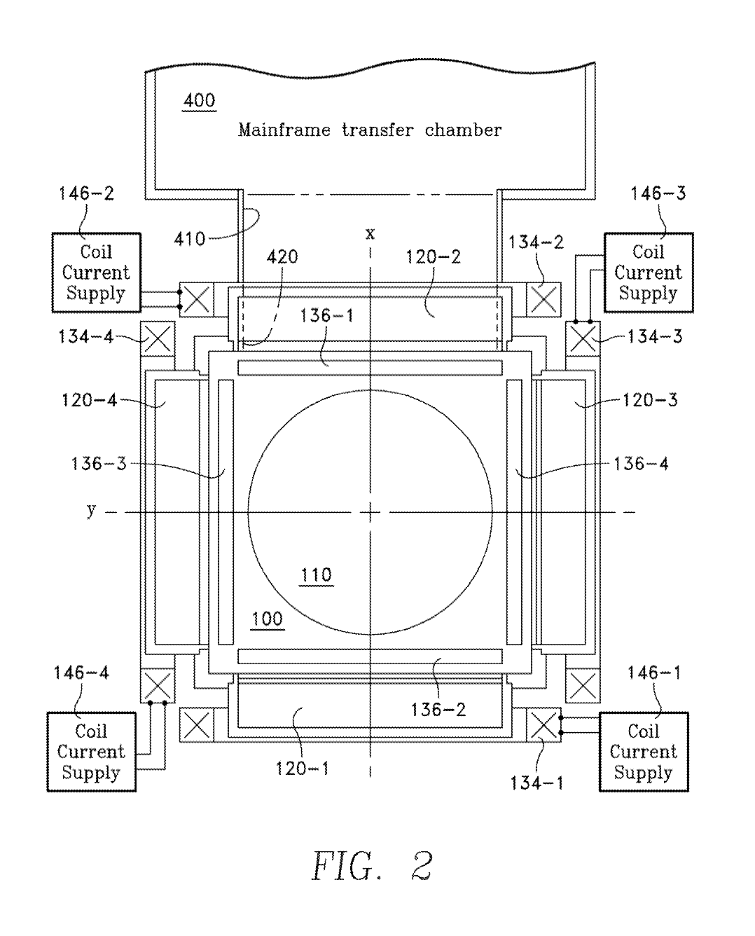

The first electron beam source 120-1 includes an extraction grid 126 between the opening 124a and the plasma generation chamber 122, and an acceleration grid 128 between the extraction grid 126 and the process region 118. The extraction grid 126 and the acceleration grid 128 may be formed as separate conductive meshes, for example. The extraction grid 126 and the acceleration grid 128 are mounted with insulators 130, 132, respectively, so as to be electrically insulated from one another and from the conductive enclosure 124. However, the acceleration grid 128 is in electrical contact with the side wall 102 of the chamber 100. The openings 124a and 102a and the extraction and acceleration grids 126, 128 are mutually congruent, generally, and define a thin wide flow path for an electron beam into the processing region 118. The width of the flow path is about the diameter of the workpiece 110 (e.g., 100-500 mm), as depicted in FIG. 2, while the height of the flow path is less than about two inches. Electrons are extracted from the plasma in the chamber 122 through the extraction grid 126, and accelerated through the acceleration grid 128 due to a voltage difference between the acceleration grid and the extraction grid to produce an electron beam that flows into the processing chamber 100.

The first electron beam source 120-1 further includes a first pair of electromagnets 134-1 and 134-2 aligned with the first electron beam source 120-1, and producing a magnetic field parallel to the direction of the electron beam. The electron beam flows across the processing region 118 over the workpiece 110, and is absorbed on the opposite side of the processing region 118 by a first beam dump 136-1. The first beam dump 136-1 is a conductive body having a shape adapted to capture the wide thin electron beam.

A negative terminal of a plasma D.C. discharge voltage supply 140-1 is coupled to the conductive enclosure 124, and a positive terminal of the voltage supply 140-1 is coupled to the extraction grid 126. In turn, a negative terminal of an electron beam acceleration voltage supply 142-1 is connected to the extraction grid 126, and a positive terminal of the voltage supply 142-1 is connected to the grounded sidewall 102 of the process chamber 100. A first pair of coil current supplies 146-1 and 146-2 is coupled to the first pair of electromagnets 134-1 and 134-2.

The reactor of FIG. 1A is capable of reversing the direction of electron beam flow through the processing region 118. An advantage is that this feature can reduce or correct non-uniformity in distribution of density of the electron beam along the direction of propagation (the longitudinal direction). For this purpose, there is provided a second electron beam source 120-2 identical in structure to the first electron beam source 120-1 as depicted in FIG. 1B, but facing in the opposite direction and located on the opposite side of the chamber 100. The second electron beam source 120-2 includes elements corresponding to those described above with reference to the first electron beam source 120-1, including the first pair of electromagnets 134-1 and 134-2, a D.C. discharge voltage supply 140-2, an acceleration voltage supply 142-2 and the coil current supplies 146-1 and 146-2. Also provided is a second beam dump 136-2 on the side opposite the first beam dump 136-1, and respective servos 152 for elevating and depressing the axial positions of the first and second beam dumps 136-1, 136-2 independently.

The coil current supplies 146-1 and 146-2 may be controlled so that the electromagnets 134-1 and 134-2 produce magnetic fields in the same direction. The controller 150 governs the respective servos 152 in order to position the beam dumps 136-1, 136-2 in accordance with the desired beam direction. Specifically, for electron beam propagation from right to left in FIG. 1A, the first beam dump 136-1 is elevated into the path of the electron beam from the first electron beam source 120-1, while the second beam dump 136-2 is depressed below the electron beam path.

To reverse the electron beam direction, the configuration depicted in FIG. 1C is adopted, in which the first beam dump 136-1 is depressed, while the second beam dump 136-2 is elevated. The beam dumps 136-1 and 136-2 are thus elevated alternately, so that one beam dump is elevated and blocks electron beam flow from the nearest electron beam source, while the opposite beam dump is depressed to allow electron beam flow from the opposite electron beam source.

As described above, the embodiment of FIGS. 1A and 1C includes a pair of opposing electron beam sources 120-1 and 120-2 capable of reversing electron beam propagation direction along one axis, as described, above. In a further embodiment, at least two (or more) pairs of opposing electron beam sources are provided facing one another across the processing region 118 along different axes. An advantage is that this feature may reduce or correct for non-uniformity in distribution of electron beam density along the direction transverse to electron beam flow.

For example, FIG. 2 illustrates an embodiment in which two pairs of opposing electron beam sources are provided, of which a first opposing pair of electron beam sources 120-1, 120-2 provide reversible electron beam flow along a first (“x”) axis, while a second opposing pair of electron beam sources 120-3 and 120-4 provide reversible electron beam flow along a second (“y”) axis orthogonal to the first (“x”) axis. The pairs of opposing electron beam sources are identical in structure to the electron beam sources described above with respect to FIGS. 1A and 1B. The first pair of electron beam sources 120-1 and 120-2 employ the first pair of electromagnets 134-1 and 134-2, and the second pair of electron beam sources 120-3 and 120-4 employ a second pair of electromagnets 134-3 and 134-4. The second pair of electromagnets 134-3 and 134-4 is fed by respective coil current supplies 146-3 and 146-4. Further, there is provided respective beam dump servos governing the individual movements of the respective beam dumps 136-1, 136-2, 136-3 and 136-4 between beam-blocking (raised) positions and unblocking (depressed) positions.

The controller 150 governs the respective servos 152 so as to selectively enable and reverse electron beam flow along each of the two axes.

As shown in FIG. 2, a mainframe transfer chamber 400 is coupled through a transfer port 410 to a workpiece transfer opening 420 in the sidewall 102. The transfer port 410 fits within the electromagnet 134-2 in the manner depicted in FIG. 2.

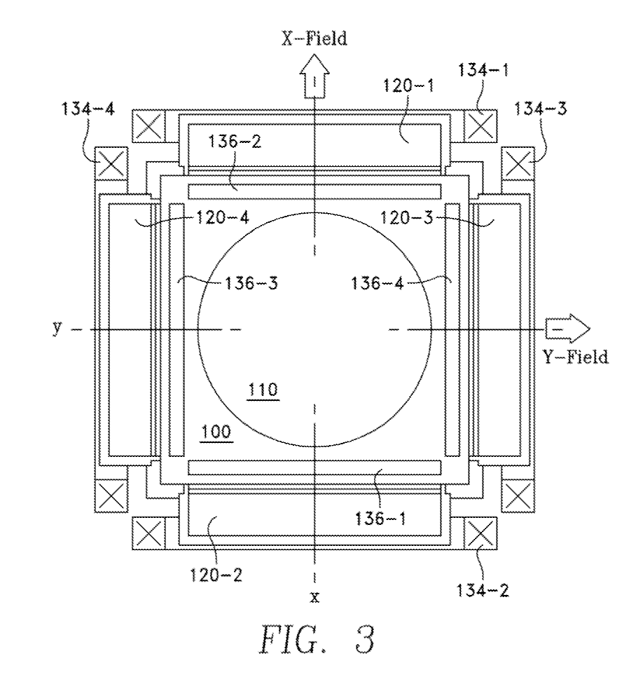

FIG. 3 depicts the magnetic fields produced for the two pairs of opposing beam sources 120-1 through 120-4. In FIG. 3, the field produced by the electromagnets 134-1 and 134-2 of the first and second electron beam sources 120-1 and 120-2 parallel to the “x” axis is labeled “x-field”. Likewise, the field produced by the electromagnets 134-3 and 134-4 of the third and fourth electron beam sources 120-3 and 120-4 parallel to the “y” axis is labeled “y-field”. Electron beam flow along the two axes may be enabled by the controller 150 alternately (asynchronously). The flow direction along each axis may be reversed periodically at a rate selected by the user, and the rate of direction reversal along each axis may be different or may be the same rate for all axes.

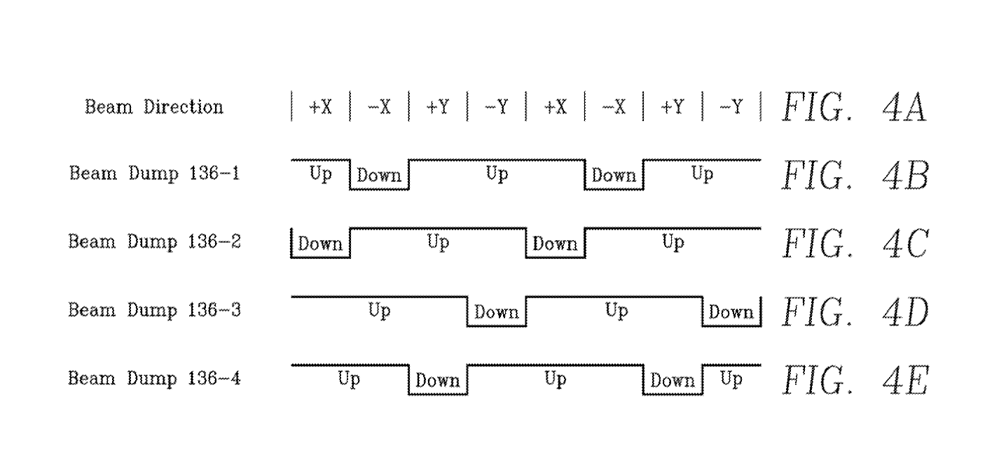

One manner of operating in the asynchronous mode is to maintain the four beam dumps 136-1 through 136-4 in their elevated or “blocking” positions (to block beam propagation), and to depress each of them one at a time (to its “unblocking position) in turn. An example of operation of the beam sources in such an asynchronous mode is depicted in FIGS. 4A through 4E. FIGS. 4A through 4E are contemporaneous timing diagrams of the electron beam propagation direction (FIG. 4A), and the positions of the beam dumps 136-1 through 136-4 (FIGS. 4B through 4E. FIGS. 4A through 4E show that the beam direction is along the x-axis in the positive direction when the beam dump 136-1 is in the “down” position, and is along the x-axis in the negative direction when the beam dump 136-2 is “down”, and is along the y-axis in the positive direction when the beam dump 136-3 is “down”, and is along the y-axis in the negative direction when the beam dump 136-4 is “down”.

In the sequence illustrated in FIGS. 4A through 4E, the electron beam propagation direction is along the X-axis, then the beam direction is reversed so that it is along the negative X-axis. Thereafter, beam flow along the X-axis is halted and is established instead along the Y-axis, which is in effect a 90 degree rotation of the beam direction. The beam direction is then reversed to be along the negative Y-axis, and the entire sequence repeated. The foregoing sequence consists of propagating the electron beam along one axis, reversing the beam direction along the one axis, then rotating the beam direction to align with the other axis, and then reversing beam flow along the other axis. The beam direction is again rotated to align with the first axis, and the entire sequence is repeated.

In an optional embodiment, the sequence of reversal and rotation is a series of successive beam rotations, in which the beam direction is first established along one axis (e.g., positive X-axis), and is then rotated to be along the other axis (e.g., positive Y-axis), and is then rotated again to be along the first axis, but in the negative direction (e.g., negative X-axis), and is rotated yet again to be along the second axis but in the negative direction (e.g., negative Y-axis).

Each electron beam source 120-1 through 120-4 may be of the D.C. gas discharge type depicted in FIGS. 1-3. However, any suitable mode of plasma generation may be employed not limited to D.C. gas discharge. For example, the electron beam source may include a toroidal plasma source, an inductively coupled plasma source, or a capacitively coupled plasma source.

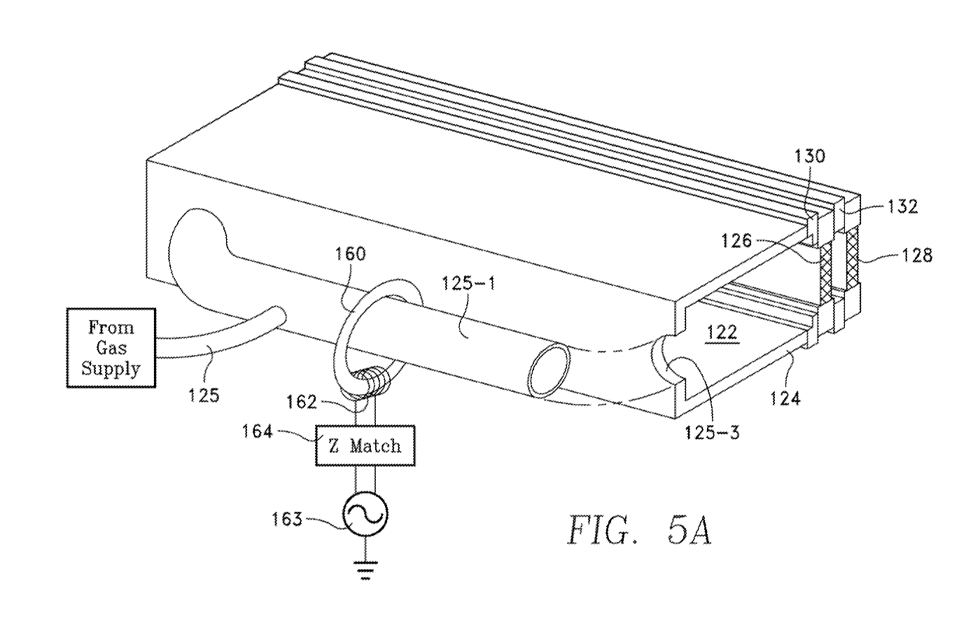

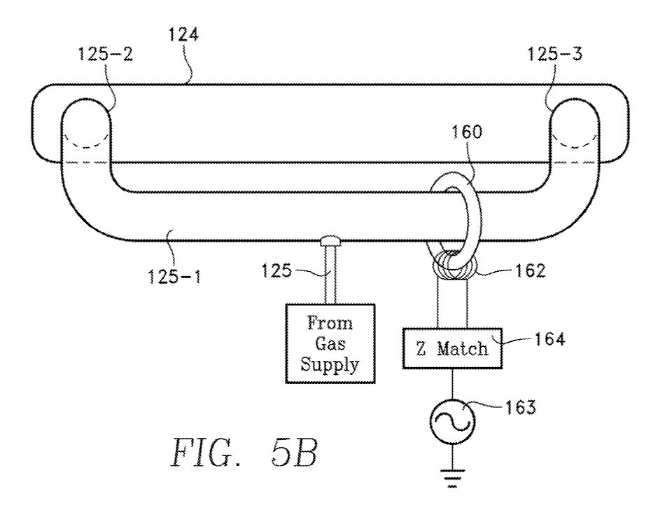

FIGS. 5A and 5B depict the electron beam source 120-1 of FIG. 1A modified to employ a toroidal plasma source power applicator including a ferrite ring 160 surrounding a reentrant conduit 125-1 coupled to the gas inlet 125, a coil 162 surrounding the ring 160 and an RF power generator 163 coupled to the coil 162 through an impedance match 164. FIG. 5B shows that the reentrant conduit 125-1 is coupled to the chamber enclosure 124 at a pair of ports 125-2 and 125-3, in the manner of a toroidal plasma source.

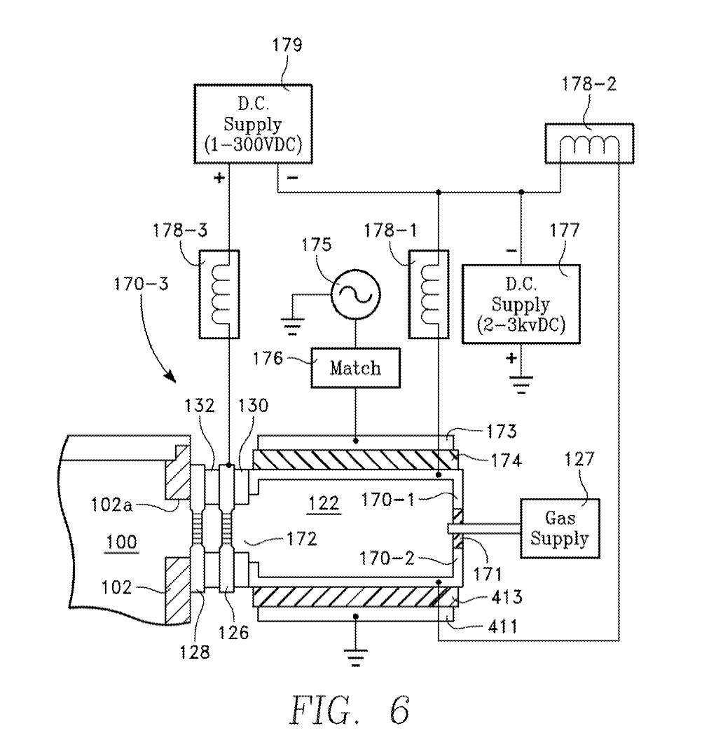

FIG. 6 depicts the electron beam source 120-1 of FIG. 1A modified to include a capacitively coupled RF plasma source integrated with the chamber 122. The capacitively coupled plasma source has a conductive enclosure consisting of an upper enclosure 170-1 and a lower enclosure 170-2. At one end of the chamber 122, the upper enclosure 170-1 is separated from the lower enclosure 170-2 by a dielectric spacer 171. At an opposite end of the chamber 122, the upper and lower enclosures 170-1 and 170-2 are separated by an emission aperture 172 facing the extraction grid 126. An RF-hot source electrode 173 is provided adjacent the upper enclosure 170-1 and is separated from the upper enclosure 170-1 by a dielectric layer 174. An RF-cold electrode 411 (ground return) overlies the lower enclosure 170-2 and is separated from it by a dielectric layer 413. An RF source power generator 175 is coupled to the RF source electrode 173 through an impedance match 176. A negative terminal of a high D.C. voltage supply 177 is connected to the upper enclosure 170-1 and to the lower enclosure 170-2 through respective choke inductors 178-1, 178-2. Alternatively, the negative terminal of the high D.C. voltage supply 177 may be connected to the extraction grid 126 through a choke inductor. A positive terminal of the high DC voltage supply 177 is connected to ground. A negative terminal of a low D.C. voltage supply 179 is connected to the negative terminal of the high D.C. voltage supply 177. A positive terminal of the low D.C. voltage supply 179 is connected to the extraction grid 126 through a choke inductor 178-3. The RF source power generator 175 provides power to produce a capacitively coupled plasma in the chamber 122. The choke inductors 178-1, 178-2, and 178-3 enable the RF generator 175 to maintain an RF voltage difference between the lower and upper enclosures 170-1 and 170-2 required for the capacitive discharge, and prevent an RF short of the generator through the D.C. voltage supplies. In one example, the frequency of the RF source power generator 175 may be 60 MHz and the inductance of the choke inductors 178-1, 178-2, 178-3 may be one microHenry. The high D.C. voltage supply 177 may provide a voltage in the range of a few to several kiloVolts. The low D.C. voltage supply 179 may provide a voltage in the range of a few to several hundred volts. The net electron extraction potential is the difference between the voltages of the high and low D.C. voltage supplies 177 and 179. Despite the fact that in this embodiment the main source of plasma in the e-beam source chamber 122 is the capacitively coupled discharge, the low voltage supply 179 is still required, to eliminate an electron-repelling sheath at the discharge side of the extraction grid 126, and thus ensure that electrons can leave the e-beam discharge chamber through the extraction grid. In one embodiment, the e-beam source gas from the gas supply 127 of FIG. 1A may be introduced into the main chamber 100 from which it diffuses into the e-beam source chamber 122 of FIG. 6, so that a gas feed directly connected to the e-beam source chamber 122 (as shown in FIG. 6) is not necessarily required. In an embodiment in which the e-beam source gas supply 127 is directly connected to the e-beam source chamber 122, as illustrated in FIG. 6, then it may be desirable to connect to the chamber 122 of FIG. 6 a vacuum pump (not shown) separate from the main chamber vacuum pump 116 of FIG. 1A.

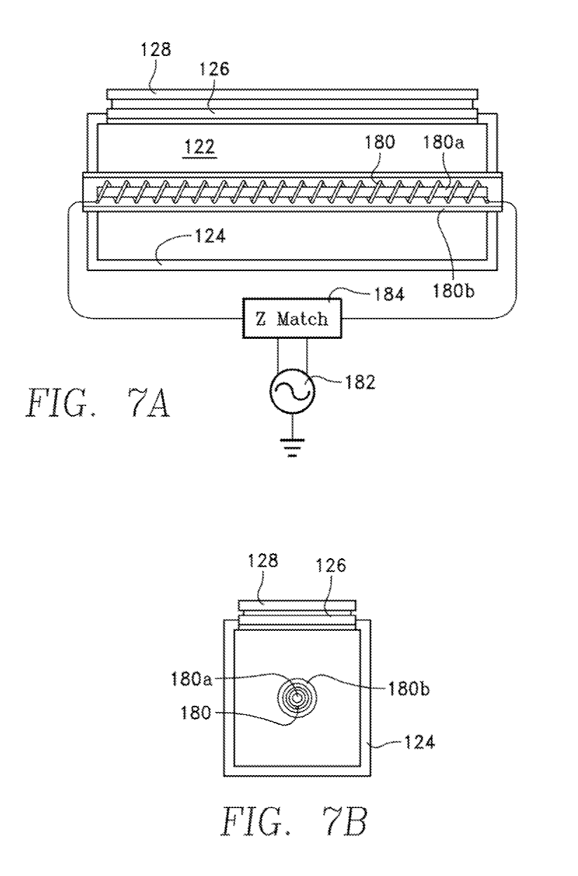

FIGS. 7A and 7B depict the electron beam source 120-1 of FIG. 1A modified to include an inductively coupled RF plasma source, including a coil antenna 180 adjacent the enclosure 124 and an RF power generator 182 coupled to the coil antenna 180 through an RF impedance match 184. The coil 180 is wrapped around a support rod 180a, which may be a ferrite or a dielectric. A dielectric tube 180b surrounds the coil 180.

In an alternative embodiment, the mechanically positionable beam dumps 136-1 through 136-4 may be eliminated. In this alternative embodiment, the beam dump for a particular one of the electron beam sources may be the opposing beam source, whose chamber enclosure 124 and has been temporarily connected to ground, while its plasma source power is temporarily switched off. For example, while the electron beam source 120-1 produces an electron beam, the opposing electron beam source 120-2 is turned off (e.g., by disabling its discharge voltage supply 140-2 and its acceleration voltage supply 142-2) and the plasma source enclosure 124 of the opposing beam source 120-2 is temporarily connected to ground. Thus each electron beam source 120-1 through 120-4 functions as a beam dump at different times in the periodic manner discussed above with reference to the mechanically positionable beam dumps 136-1 through 136-4.

While the foregoing is directed to embodiments of the present invention, other and further embodiments of the invention may be devised without departing from the basic scope thereof, and the scope thereof is determined by the claims that follow.

What is claimed is:

1. A plasma reactor comprising:
a processing chamber comprising a side wall, a floor and a ceiling;
a workplace support pedestal within said chamber having a workplace support plane and defining a processing region between said workplace support plane and said ceiling;
an array of electron beam sources having respective beam emission axes facing said processing region, said array of electron beam sources being outside of said chamber, said side wall comprising respective apertures in registration with respective ones of said beam emission axes;
an array of beam dumps aligned with said array of electron beam source and respective servos coupled to respective ones of said beam dumps, each of said beam dumps being separately movable between a beam-blocking position and an unblocking position; and
a controller coupled to said respective servos.

2. The plasma reactor of claim 1 further comprising:
an array of beam-confining magnetic field sources aligned with respective ones of said beam emission axes;
respective current sources coupled to respective ones of said beam-confining magnetic field sources and having reversible current polarities;
wherein said controller is further coupled to said respective current sources.

3. The plasma reactor of claim 2 wherein opposing pairs of said electron beam sources share respective ones of said beam emission axes.

4. The plasma reactor of claim 3 wherein said controller is programmed to periodically cause a reversal of electron beam propagation direction along respective ones of said beam emission axes.

5. The plasma reactor of claim 4 wherein said controller is further programmed to enable electron beam propagation along different ones of said beam emission axes at different times.

6. A plasma reactor comprising:
a processing chamber comprising a side wall, a floor and a ceiling;
a workpiece support pedestal within said chamber having a workpiece support plane and defining a processing region between said workpiece support plane and said ceiling;
a first pair of electron beam sources outside of said chamber and disposed on opposing sides of said process region and facing one another along a first axis, each of said first pair of electron beam sources having an electron beam emission aperture and an electron beam propagation direction parallel to said first axis, said side wall comprising respective openings facing respective ones of the electron beam emission apertures of said first pair of electron beam sources;
first and second beam dumps adjacent respective ones of said electron beam emission apertures, each of said first and second beam dumps being movable between an electron beam blocking position and a non-blocking position, and first and second servos coupled to said first and second beam dumps, respectively;
a first electromagnet having a field direction parallel to said first axis and a first current supply coupled to said first electromagnet and having a switchable polarity; and
a controller coupled to said first and second servos and to said first current supply.

7. The plasma reactor of claim 6 wherein said controller is programmed for moving said first and second beam dumps between their respective blocking and unblocking positions and switching current polarity in said first current supply whereby to reverse direction of electron beam propagation along said first axis.

8. The plasma reactor of claim 6 further comprising:
a second pair of electron beam sources outside of said chamber and disposed on opposing sides of said process region and facing one another along a second axis transverse to said first axis, each of said second pair of electron beam sources having an electron beam emission aperture and an electron beam propagation direction parallel to said second axis, said side wall comprising respective openings facing respective ones of the electron beam emission apertures of said second pair of electron beam sources;
third and fourth beam dumps adjacent respective ones of the electron beam emission apertures of said second pair of electron beam sources, each of said third and fourth beam dumps being movable between an electron beam blocking position and a non-blocking position, and third and fourth servos coupled to said third and fourth beam dumps, respectively;
a second electromagnet having a field direction parallel to said second axis and a second current supply coupled to said second electromagnet and having a switchable polarity; and
wherein said controller is further coupled to said second and third servos and to said second current supply.

9. The plasma reactor of claim 6 wherein said controller is programmed for moving said third and fourth beam dumps between their respective blocking and unblocking positions and switching current polarity of said second current supply whereby to reverse direction of electron beam propagation along said second axis.

10. The plasma reactor of claim 6 wherein said first and second axes are orthogonal to one another.

11. The plasma reactor of claim 6 wherein each of said electron beam sources comprises a plasma source of one of the following types: (a) toroidal plasma source, (b) D.C. gas discharge plasma source, (c) inductively coupled plasma source, (d) capacitively coupled plasma source.

12. The plasma reactor of claim 6 wherein each of said electron beam sources comprises:
a source enclosure, said electron beam emission aperture comprising an opening in said source enclosure, an insulated extraction grid in said electron beam emission aperture and an insulated acceleration grid between said insulated extraction grid and said processing chamber, and a gas inlet in said source enclosure.

13. A method of operating a plasma reactor having an electron beam source, comprising:
introducing a processing gas into processing region of said plasma reactor;
introducing electron beams into said processing region of said plasma reactor along respective beam emission axes extending along respective radial directions; and
periodically reversing direction of electron beam propagation along respective ones of said beam emission axes.

14. The method of claim 13 further comprising producing respective beam-confining magnetic fields along the respective ones of said beam emission axes, and reversing directions of said respective magnetic fields in cooperation with the reversal of electron beam propagation direction along the respective ones of said beam emission axes.

15. The method of claim 14 further comprising enabling electron beam propagation along different ones of said respective beam emission axes at different times.
